(19) United States
(12) Patent Application Publication
(10) Pub. No.: US 2020/0064845 A1
(43) Pub. Date: Feb. 27, 2020

(54) UNMANNED AERIAL VEHICLE AND MOVING OBJECT CAPTURING SYSTEM

(71) Applicant: PRODRONE CO., LTD., Nagoya-shi (JP)

(72) Inventors: Kiyokazu SUGAKI, Nagoya-shi (JP); Kazuo ICHIHARA, Nagoya-shi (JP)

(73) Assignee: PRODRONE CO., LTD., Nagoya-shi (JP)

(21) Appl. No.: 16/593,225

(22) Filed: Oct. 4, 2019

Related U.S. Application Data
(62) Division of application No. 16/095,534, filed on Oct. 22, 2018.

(51) Int. Cl. G05D 1/00; B64C 39/02; B64D 7/00; F41H 11/02; G05D 1/12; F41H 13/00

(52) U.S. Cl. CPC G05D 1/0094; B64C 39/024; B64D 7/00; F41H 11/02; B64C 2201/12; B64C 39/02; F41H 13/0006; B64C 2201/027; G05D 1/12

(57) ABSTRACT

To provide such an unmanned aircraft and such a moving object capturing system that quickly disable an unidentified object that has intruded into a predetermined airspace.

The problem is solved by an unmanned aerial vehicle that includes a plurality of rotary wings, a capturing net launching device, and a launching direction controller. The capturing net launching device is configured to launch and spread a capturing net. The launching direction controller is configured to hold the capturing net launching device to control an aiming direction of the capturing net launching device independently of a direction in which an airframe of the unmanned aerial vehicle is pointed. The problem is also solved by a moving object capturing system that includes a monitor configured to monitor a predetermined space, the unmanned aerial vehicle according to the present invention, and an intermediate processor communicable with the monitor and the unmanned aerial vehicle.

### CROSS-REFERENCE TO RELATED APPLICATION (S)

This application is a divisional of U.S. application Ser. No. 16/095,534 filed Oct. 22, 2018, which is based on and claims priority under 35 U.S.C. 119 from International Patent Application No. PCT/JP2016/071240 filed on Jul. 20, 2016. The contents of the above applications as e incorporated herein by reference.

### TECHNICAL FIELD

The present invention relates to an unmanned aerial vehicle and a moving object capturing system.

### BACKGROUND ART

Conventional small-size unmanned aerial vehicles represented by industrial unmanned helicopters have had airframes too expensive to be affordable. Also, these vehicles used to require skillful pilotage for stable flight. In recent years, however, there have been considerable improvements in sensors and software used to control posture of unmanned aerial vehicles and to implement autonomous flight of unmanned aerial vehicles. This has led to considerable improvement in manipulability of unmanned aerial vehicles and availability of high-end airframes at lower prices Under the circumstances, multi-copters, especially small size multi-copters, are currently not only used for hobbyist purposes hut also applied to various missions in a wide range of fields.

### CITATION LIST

### Patent Literature

PTL1: JP 2014-119827A

PTL2: WO 2007/046194A1

PTL3: JP 2013-16816A

### SUMMARY OF INVENTION

### Technical Problem

In the meantime, as multi-copters became easily available, there has been an urgent need for measures against abuse of multi-copiers, such as causing a multi-copter to fly over a shield such as a wall and a fence to enter a private land or an off-limits area; and spying on something or someone from up in the air using a multi-copter.

For example, in a security system recited in PTL1, a multi-copier is used to patrol around a facility. This multi-copter, however, is intended for outdoor use to flexibly take pictures of characteristics of an automobile of an intruder in an attempt to contribute to post-incident investigations. In the security system recited in PTL1, flying vehicles such as multi-copters are not considered as intruders. It is, therefore, natural that the security system is not equipped with a means for disabling an intruding multi-copter on site.

When a capturing net launching device such as one recited in PTL3 is used to hold a multi-copter entering an off-limits area before the multi-copter escapes from the off-limits area, it is possible that the capturing net falls short of reaching the flight position of the multi-copter. The capturing net launching device may launch the capturing net perpendicularly upward, which is the direction of longest flying distance in upward directions. This can be dangerous in that the captured multi-copter may fall on the head of the operator. Also, the falling capturing net may become entangled with the operator. In light of the circumstances, in launching a capturing net upward, it is necessary to launch the capturing net diagonally upward. However, multi-copters can escape being captured in the capturing net only by slightly raising the flight altitude.

In light of the above-described problems, a problem to be solved by the present invention is to provide such an unmanned aircraft and such a moving object capturing system that quickly disable an unidentified object that has intruded into a predetermined airspace.

### Solution to Problem

In order to solve the above-described problem, an unmanned aerial vehicle according to the present invention includes a plurality of rotary wings, a capturing net launching device, and a launching direction controller. The capturing net launching device is configured to launch and spread a capturing net. The launching direction controller is configured to hold the capturing net launching device to control an aiming direction of the capturing net launching device independently of a direction in which an airframe of the unmanned aerial vehicle is pointed.

The unmanned aerial vehicle is equipped with a capturing net launching device that is capable of launching a capturing net in the air. This ensures that multi-copters or other capturing targets that are difficult to capture down from the ground can be captured. However, the practice to adjust the launching direction of the capturing net by changing the nose direction of the airframe of the unmanned aerial vehicle or by changing the altitude of the unmanned aerial vehicle makes it difficult to capture capturing targets freely moving in the air. The unmanned aerial vehicle according to the present invention includes a launching direction controller that is movable independently of the direction in which the airframe is pointed. By adjusting the direction in which the capturing net launching device is pointed by mainly using the launching direction controller, the launching direction of the capturing net is flexibly changeable following the movement of the capturing target.

An unmanned aerial vehicle equipped with a plurality of rotary wings controls the posture of the airframe and the flight operation by adjusting the number of rotations of the rotary wings. A feature of such unmanned aerial vehicle is that the movement of the airframe in horizontal directions and the speed of the airframe are adjusted by inclining the airframe. With the launching direction controller, the unmanned aerial vehicle according to the present invention keeps the capturing net launching device directed in a desired direction even when the airframe is inclined.

When the capturing target is a human being or an animal, the unmanned aerial vehicle according to the present invention, which includes the capturing net launching device, may be operated remotely. This ensures that the capturing target is disabled while the operator is located at a safe place.

The launching direction controller may preferably hold a plurality of the capturing net launching devices. The launching direction controller may preferably hold the plurality of the capturing net launching devices at such launching angles that when the plurality of the capturing net launching devices have launched the capturing nets simultaneously, the spread capturing nets are substantially out of contact with each other with no or minimal gaps between the spread capturing nets.

Even when it is difficult to capture a capturing target using a single capturing net launching device, since a plurality of capturing net launching devices are arranged and the capturing range of the capturing nets launched from the capturing net launching devices is maximized, the capturing target can be captured more reliably. In this case, the capturing nets may preferably be launched simultaneously or approximately simultaneously.

The plurality of the capturing net launching devices may preferably be disposed in a suitable arrangement and at suitable launching angles enough to cover an estimated movable range that is based on a movement characteristic of a capturing target.

The movable range of a capturing target at the time of launching of the capturing net is estimated based on movement characteristics of the capturing target, such as moving means, moving speed, movable directions, agility in changing directions, and restrictions in making a movement. The capturing net launching device is arranged to cover as much of the movable range as possible. This increases the success rate of capturing the capturing target.

The plurality of the capturing net launching devices may preferably be arranged such that one capturing net launching device of the plurality of the capturing net launching devices is located at a center of the plurality of the capturing net launching devices, and other capturing net launching devices are located at horizontal sides of the one capturing net launching device and perpendicularly above the one capturing net launching device.

For example, assume that the capturing target is a multi-copter flying in the air. The nature of the multi-copter makes it difficult to suddenly move backward or downward. In light of the circumstances, the capturing nets are spread in the linear movement direction of the capturing-target multi-copter, in the leftward and rightward directions relative to the linear movement direction, and in the upward direction of the capturing-target multi-copter. This increases the success rate of capturing the multi-copter.

The capturing net may preferably include: a spreadable, portion spreadable to become entangled with a capturing target after the capturing net has been launched; and a string-shaped portion connecting the spreadable portion and the capturing net launching device to each other. The capturing net launching device may preferably include a winch configured to wind out and wind up the string-shaped portion.

For example, when the capturing target is an object, such as a multi copter, that is flying in the air, the capturing target captured in the capturing net falls on the ground. If there is a structure or a pedestrian on the falling spot, the falling of the capturing target may lead to an accident. Such an accident can be avoided in advance by connecting the spreadable portion of the capturing net to the capturing net launching device using the string-shaped portion of the capturing net and by, after capturing the capturing target, suspending the captured capturing target from the airframe. In this respect, in order to suspend the captured capturing target from the airframe, it is necessary to adjust the string-shaped portion to a length at which the captured capturing target is kept off the ground. Thus, the string-shaped portion restricts the effective launching range of the capturing net launching device. In the unmanned aerial vehicle with the above-described configuration, the capturing net launching device includes a winch that winds up the string-shaped portion upon reaching of the spreadable portion to the capturing target. This ensures that the effective launching range of the capturing net launching device is secured, and the function of suspending the captured capturing target is secured at the same time.

The unmanned aerial vehicle may preferably include automatic tracking means for obtaining a position of a capturing target or the position and a speed of the capturing target and for causing the unmanned aerial vehicle to fly autonomously to a predetermined relative position that is based on the position or the position and the speed.

The unmanned aircraft includes automatic tracking means for causing the unmanned aircraft to automatically fly to a position at which the capturing target can be easily captured. This enables the operator of the unmanned aircraft to focus on the manipulation of the launching direction controller and the launching operation of the capturing nets.

The unmanned aerial vehicle may preferably include target capturing means for obtaining a position of a capturing target and for automatically changing the aiming direction of the capturing net launching device to a direction toward the capturing target.

The unmanned aircraft includes target capturing means that automatically directs the capturing net launching device toward the capturing target. This enables the operator of the unmanned aircraft to focus on the manipulation of the airframe and the launching operation of the capturing nets. In the case where the unmanned aircraft further includes automatic tracking means, the operator is able to focus on the launching operation of the capturing nets.

The unmanned aerial vehicle may preferably include automatic launching means for automatically launching the capturing net upon entering of the capturing target into a launching range of the capturing net launching device.

The unmanned aerial vehicle includes automatic tracking means for the capturing target and automatic launching means for the capturing net. This ensures that all of the airframe manipulation is automated after the capturing target has been identified. This realizes quick judgments and manipulations that are impossible to make manually, ensuring that the capturing target can be captured more reliably.

Based on a time difference between a launching of the capturing net and a reaching of the capturing net to the capturing target, the automatic launching means may preferably be configured to estimate the position of the capturing target at a point of time when the capturing net reaches the capturing target, and configured to adjust the launching direction of the capturing net based on the estimated position.

For example, when the capturing target is an object, such as a multi-copter, that moves in the air at high speed, the capturing target may escape from the capturing net due to a time lag between the launching of the capturing net and the reaching of the capturing net to the capturing target. This is particularly notable when it is difficult to make the distance between the unmanned aerial vehicle and the capturing target sufficiently short. In this case, for example, the position of the capturing target at the time of reaching of the capturing net to the capturing target is estimated based on the movement direction and movement speed of the capturing target at the time of launching of the capturing net. Then, the capturing net is launched to the estimated position. This increases the success rate of capturing the capturing target. In this manner, the unmanned aerial vehicle with the above-described configuration determines the launching direction of the capturing net based on a time lag between the launching of the capturing net and the reaching of the capturing net to the capturing target. This ensures that the capturing target can be captured more reliably.

The launching direction controller may preferably hold a plurality of the capturing net launching devices, and the automatic launching means may be configured to sequentially launch the capturing nets from the capturing net launching devices.

For example, even when the estimation of movement of the capturing target was a mis-estimation and the capturing target has escaped from the capturing net, repeating the estimation operation and the launching operation a plurality of times increases the possibility of the capturing target positioned as estimated.

The capturing net may preferably include: a spreadable portion spreadable to become entangled with a capturing target after the capturing net has been launched; and a string-shaped portion connecting the spreadable portion and the capturing net launching device to each other. The unmanned aerial vehicle may preferably include automatic dumping means for, after capturing the capturing target using the capturing net, carrying the capturing target to a predetermined dumping position with the capturing target in a suspended state, and for dumping the capturing target to the dumping position and causing the unmanned aerial vehicle to make a returning movement or land on the dumping position.

For example, when the capturing target is an object, such as a multi-copier, that flies in the air, the capturing target captured in the capturing net falls on the ground. If there is a structure or a pedestrian on the falling spot, the falling of the capturing target may lead to an accident. Such an accident can be avoided in advance by connecting the spreadable portion of the capturing net to the capturing net launching device using the string-shaped portion of the capturing net and by, after capturing the capturing target, suspending the captured capturing target from the airframe and carrying the capturing target to a safe place.

In order to solve the above-described problem, a moving object capturing system according to the present invention includes a monitor configured to monitor a predetermined space; the unmanned aerial vehicle according to the present invention; and an intermediate processor communicable with the monitor and the unmanned aerial vehicle. The monitor includes monitoring means for obtaining monitoring information that is information indicating a state of a monitored space of the monitor. The intermediate processor includes position identifying means for detecting, based on the monitoring information, the capturing target that has entered the monitored space, and for identifying a position of the capturing target in the monitored space. The unmanned aerial vehicle is configured to obtain the position of the capturing target identified by the intermediate processor.

The functions necessary for capturing the capturing target are assigned to different elements, namely, the monitor that obtains monitoring information; the intermediate processor that identifies the position of the capturing target based on the monitoring information; and the unmanned aerial vehicle that captures the capturing target based on the position information identified by the intermediate processor. This ensures that a capturing-target moving object is disabled more reliably and more efficiently.

### Advantageous Effects of Invention

Thus, the unmanned aerial vehicle and the moving object capturing system according to the present invention quickly disable an unidentified object that has intruded into a predetermined airspace.

### BRIEF DESCRIPTION OF DRAWINGS

FIG. 1 is a perspective view of an exterior appearance of a multi-copter according to a first embodiment.

FIGS. 2A to 2C illustrate partially enlarged views of a method of arranging net launchers.

FIG. 3 is a schematic illustrating a structure of a capturing net launched from a net launcher.

FIG. 4 is a block diagram illustrating a functional configuration of the multi-copter according to the first embodiment.

FIG. 5 is a perspective view of an exterior appearance of a multi-copier according to a second embodiment.

FIG. 6 is a block diagram illustrating a functional configuration of the multi-copter according to the second embodiment.

FIGS. 7A and 7B illustrate schematics illustrating a process by which the multi-copter captures a capturing target.

FIG. 8 is a schematic illustrating how the multi-copter dumps the capturing target and makes a returning movement.

FIG. 9 is a block diagram illustrating a functional configuration of a moving object capturing system.

FIG. 10 is a schematic outlining the moving object capturing system.

FIG. 11 is a schematic illustrating a net launcher that includes a winch.

FIGS. 12A to 12C illustrate partially enlarged views of another arrangement of net launchers.

FIG. 13 is a schematic illustrating a launching operation of net launchers of the multi-copter.

FIG. 14 is a schematic outlining a moving object capturing system that uses a plurality of multi-copters.

### DESCRIPTION OF EMBODIMENTS

Embodiments of the present invention will he described by referring to the accompanying drawings. The following embodiments are examples in which the unmanned aerial vehicle or the moving object capturing system according to the present invention capture capturing target that has intruded into an off-limits area. In the following embodiments, a capturing target T is a small size multi-copter, which is an unmanned aerial vehicle. The term off-limits area means an area of land to which unauthorized entrance is strictly prohibited, examples of such area including: private land such as laboratories of private companies and residential areas; and premises of nationally or publicly owned buildings, such as an official residence and a consulate, where important public figures may stay.

### First Embodiment

### [General Arrangement]

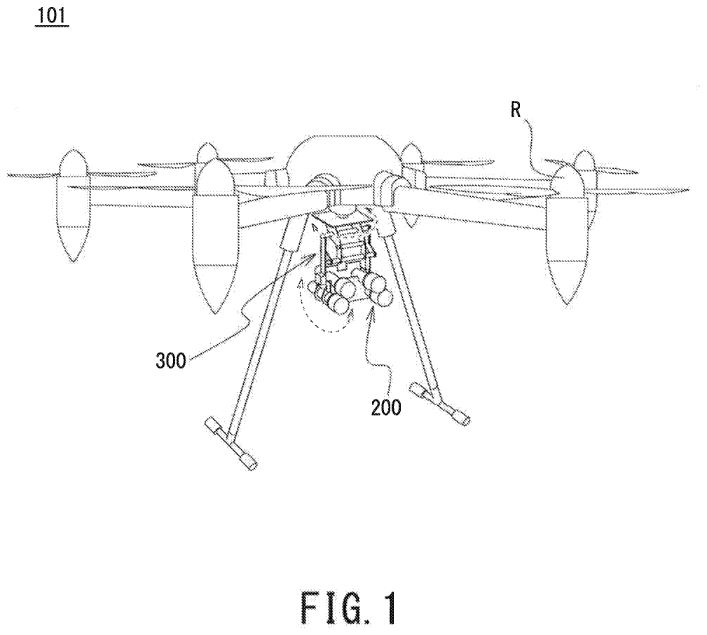

FIG. 1 is a perspective view of an exterior appearance of a multi-copter 101 according to this embodiment. The multi-copter 101 is an unmanned aerial vehicle equipped with six rotors R arranged at equal intervals in a circumferential direction of the airframe. The multi-copier 101, at a lower portion of the airframe, is connected with a net launcher driver 300. On the net launcher driver 300, a net launcher 200 is arranged. The net launcher 200 includes four net launchers. The net launcher 200 is a capturing net launching device that launches a capturing net to capture the capturing target T. The net launcher driver 300 is a launching direction controller capable of controlling, independently of the direction in which the airframe of the multi-copter 101 is pointed, the aiming direction of the net launcher 200 to change to vertical directions and circumferential directions as seen in FIG. 1.

The multi-copter 101 according to this embodiment is an unmanned aerial vehicle that is equipped with a plurality of rotary wings and that controls the posture of the airframe and the flight operation by adjusting the number of rotations of the rotary wings. A feature of such unmanned aerial vehicle is that the movement of the airframe in horizontal directions and the speed of the airframe are adjusted by inclining the airframe of the flying unmanned aerial vehicle. Equipped with the net launcher driver 300, the multi-copter 101 keeps the net launcher 200 directed in a desired direction even when the airframe is inclined.

### [Configuration of Net Launcher]

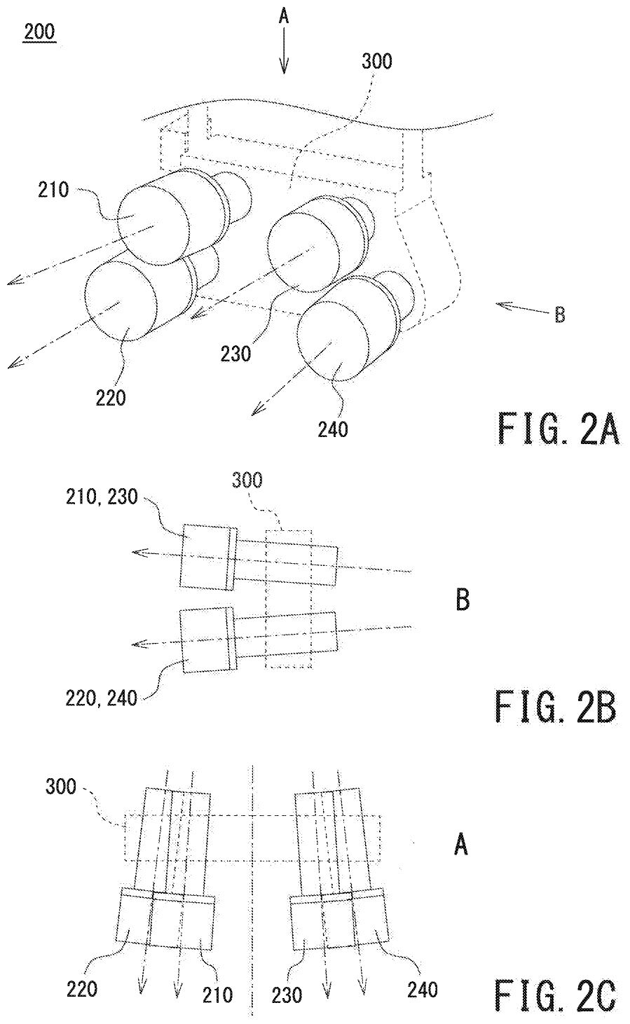

FIGS. 2A to 2C illustrate partially enlarged views of a method of arranging the net launchers constituting the net launcher 200. As illustrated in FIGS. 2A to 2C, the net launcher 200 includes net launchers 210, 220, 230, and 240, which are fixed to the net launcher driver 300 and directed in approximately the same direction.

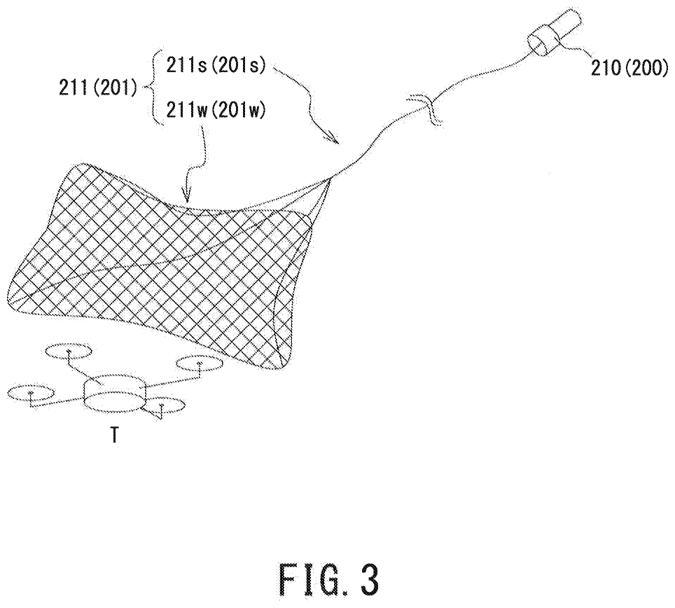

A structure of the capturing net will be described with the net launcher 210 taken as an example. FIG. 3 is a schematic illustrating a structure of a capturing net 211 launched from the net launcher 210. As illustrated in FIG. 3, the capturing net 211 includes: a spreadable portion 211w, which is spread after the capturing net has been launched and which tangles with the capturing target T; and a string-shaped portion 2115, which connects the spreadable portion 211w and the net launcher 210 to each other. The net launchers 210, 220, 230, and 240 are the same devices. Also, the capturing nets 211, 221, 231, and 241, which are respectively launched from the net launchers 210, 220, 230, and 240, have the same structures. In the following description, the capturing nets 211, 221, 231, and 241 will be occasionally collectively referred to as “capturing nets 201”; the spreadable portions of the capturing nets 201 will be occasionally collectively referred to as “spreadable portions 201w”; and the string-shaped portions of the capturing nets 201 will be occasionally collectively referred to as “string-shaped portions 201s”.

For example, as in the example of FIG. 3, when the capturing target T is a multi-copier that is flying in the air, the capturing target T is captured using a capturing net or another capturing device, becomes unable to fly, and falls on the ground. If there is a structure or a pedestrian on the falling spot, the falling of the capturing target T may lead to an accident. In the multi-copier 101 according to this embodiment, such an accident can be avoided in advance by connecting the spreadable portion 201w of the capturing net 201 to the net launcher 200 through the string-shaped portion 201s and by, after capturing the capturing target T, making the captured capturing target T suspended from the airframe. It is to be noted that since the capturing target T, which is a multi-copter, flies by rotating a plurality of rotors, when the spreadable portion 201w contacts the capturing target T, the spreadable portion 201w becomes entangled with the rotors. This makes the spreadable portion 201w firmly entangled with the capturing target T, holding the capturing target T in an inescapable manner.

It is to be noted that the structure of the capturing net according to the present invention will not be limited to the structure according to this embodiment. For example, the string-shaped portion is not necessary when the capturing target is not a flying vehicle or when there is no particular problem if the captured capturing target falls.

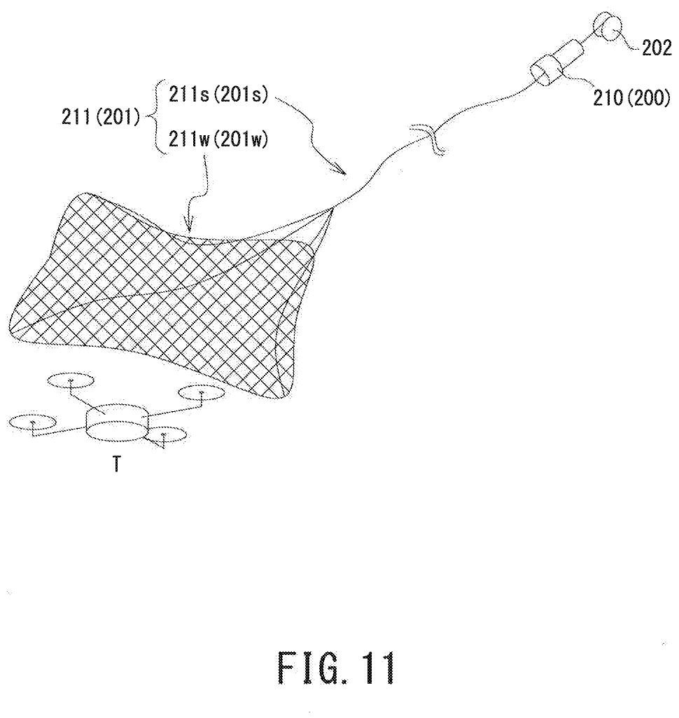

In this embodiment, in order to suspend the captured capturing target T from the airframe, the string-shaped portion 201s is adjusted to a length at which the capturing target T captured in the air is kept off the ground. In other words the string-shaped portion 201s restricts the effective launching range of the net launcher 200. Also, under the assumption that the length of the string-shaped portion 201s is constant, avoiding falling of the capturing target T on the ground requires the capturing net 201 to be launched from an altitude greater than the length of the string-shaped portion 201s. In light of the circumstances, as illustrated in FIG. 11 taking a net launcher 210 as an example, the net launcher 210 includes a winch 202, which is a winding device capable of winding out and winding up the string-shaped portion 211s. Such a configuration is possible that at the time of launching of the capturing net 211, the winch 202 winds out the string-shaped portion 211s to enable the spreadable portion 211w to reach the capturing target T; and after capturing the capturing target. T, the winch 202 winds up the string-shaped portion 211s. This ensures that the effective launching range of the net launcher 200 is secured, and the function of suspending the captured capturing target T is secured at the same time. It is to be noted that while in FIG. 11 only the net launcher 210 is taken as an example, it is necessary to provide each of the other net launchers 220, 230, and 240 with a winch or to use a single winch 202 to control all the string-shaped portions 201s of the net launcher 200.

As illustrated in FIGS. 2A to 2C, the net launchers 210, 220, 230, and 240 are arranged at such launching angles that when the capturing nets 201 have been launched simultaneously from the net launchers 210, 220, 230, and 240 and spread, the spreadable portions 201w are substantially out of contact with each other with no or minimal gaps between the spreadable portions 201w. That is, the effective area of the capturing net 201 (the area of the spreadable portion 201w) is maximized. This ensures that even when it is difficult to capture the capturing target T using a single net launcher, the capturing target T is captured at high capturing success rates. Also, the number of net launchers constituting the net launcher 200 may be more than four so that the capturing success rate further increases. It is to be noted that the net launcher 200 according to this embodiment launches the capturing nets 201 at the same timing.

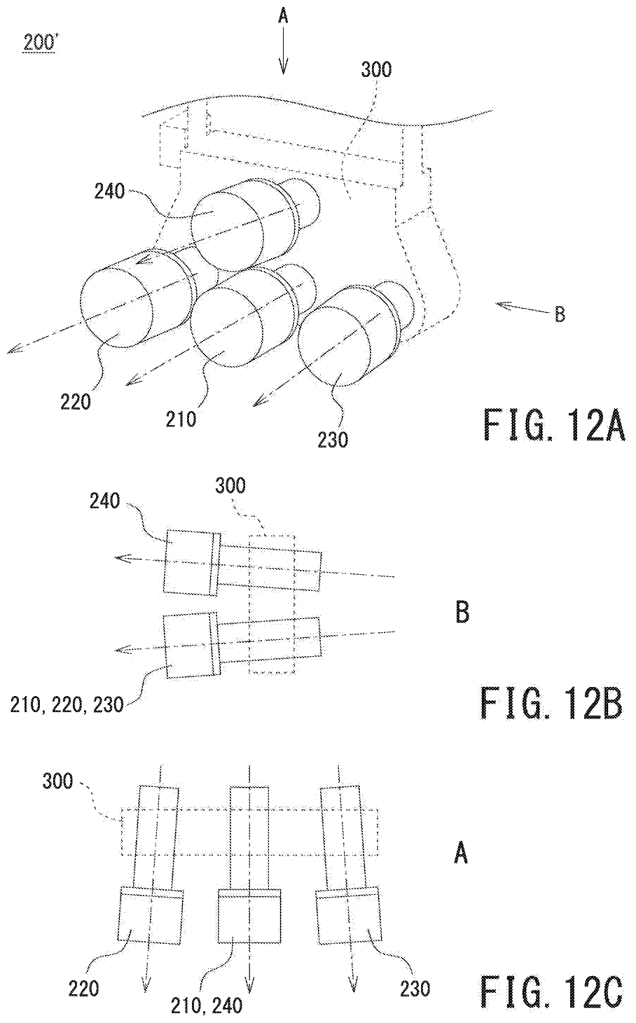

FIGS. 12A to 12C illustrate partially enlarged views of another arrangement of the net launchers 210, 220, 230, and 240. In FIG. 12, a net launcher 200 has such an arrangement that the net launcher 210 is located at the center of the net launcher 200′, that the net launchers 220 and 230 are located at horizontal sides of the net launcher 210, and that the net launcher 240 is located perpendicularly above the net launcher 210. It is to be noted that the net launcher 200′ is also arranged at such launching angles that the spreadable portions 201w are substantially out of contact with each other with no or minimal gaps between the spreadable portions 201w.

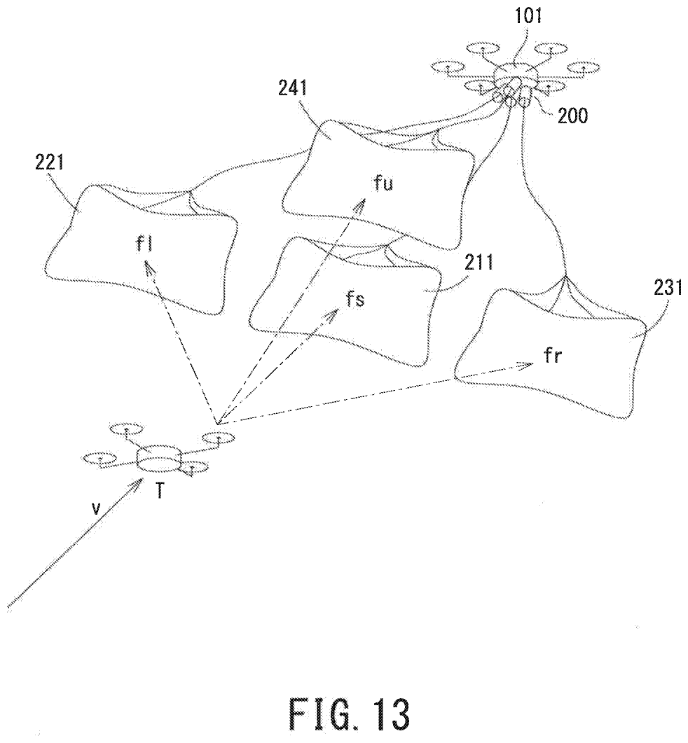

FIG. 13 is a schematic illustrating a launching operation of the net launcher 200′ of the multi-copter 101. The capturing target T according to this embodiment is a multi-copter that flies in the air. A characteristic of multi-copters is that they cannot easily make sudden backward or downward movement. In light of the circumstances, the capturing nets 211, 212, 213, and 214 are spread in linear movement direction fs of the multi-copter, which is a capturing target T, leftward direction fl and rightward direction fr relative to the linear movement direction, and in upward direction fu of the multi-copter. In this manner, the capturing nets 211, 212, 213, and 214 cover an expected moving path of the capturing target T, increasing the success rate of capturing the capturing target T.

### [Functional Configuration]

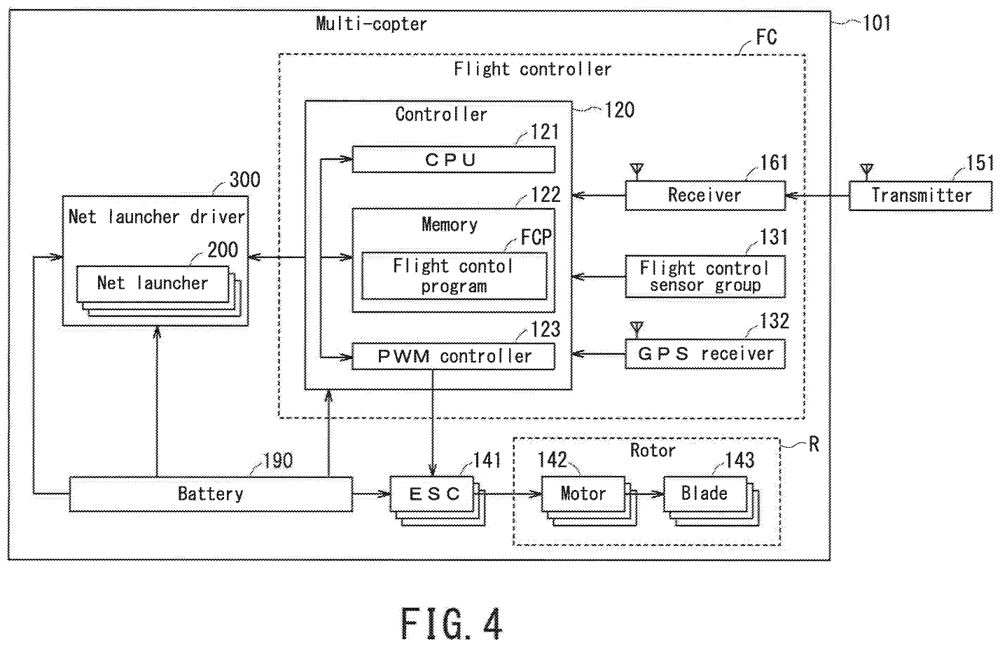

FIG. 4 is a block diagram illustrating a functional configuration of the multi-copter 101. The multi-copter 101 mainly includes: a flight controller FC; the six rotors R; an ESC 141 (Electric Speed Controller), which controls rotation of the rotors R; the net launcher 200; the net launcher driver 300; and a battery 190, which supplies power to the foregoing elements.

Each of the rotors R includes a motor 142 and a blade 143, which is connected to the output shaft of the motor 142. The ESC 141 is connected to the motor 142 of the rotor R and causes the motor 142 to rotate at a speed specified by the flight controller FC. There is no particular limitation to the number of rotors of the multi-copter 101; the number of rotors may be determined considering required flight stability, cost tolerated, and other considerations. As necessary, the multi-copter may be changed to: a tricopter, which has three rotors R; an octocopter, which has eight rotors R; and even a multi-copter having more than eight rotors.

The flight controller FC includes a controller 120, which is a micro-controller. The controller 120 includes: a CPU 121, which is a central processing unit; a memory 122, which is a storage such as ROM and RAM; and a PWM (Pulse Width Modulation) controller 123, which controls the number of rotations of each motor 142 through the ESC 141.

The flight controller FC further includes a flight control sensor group 131 and a GPS receiver 132 (these will be hereinafter occasionally referred to as “sensors”). The flight control sensor group 131 and the GPS receiver 132 are connected to the controller 120. The flight control sensor group 131 of the multi-copter 101 according to this embodiment includes a three-axis acceleration sensor, a three-axis angular velocity sensor, a pneumatic sensor (altitude sensor), and a geomagnetic sensor (direction sensor). The controller 120 is capable of obtaining, from these sensors, how much the airframe is inclined or turning, latitude and longitude of the airframe on flight, altitude, and position information of the airframe including nose azimuth.

The memory 122 of the controller 120 stores a flight control program FCP, in which an algorithm for controlling the posture of the multi-copter 101 during flight and controlling basic flight operations is described. In response to an instruction from an operator (transmitter 151), the flight control program FCP adjusts the number of rotations of each rotor R based on information obtained from the sensors so as to correct the posture and/or position of the airframe while the multi-copter 101 is making a flight.

Thus, the multi-copier 101 according to this embodiment has high-level flight control functions. It is noted, however, that insofar as the unmanned aerial vehicle according to the present invention is a flight vehicle that includes a plurality of rotors R and that controls the posture of the airframe and the flight operation by adjusting the number of rotations of each rotor R, the unmanned aerial vehicle may be a flight vehicle in which, for example, some of the sensors are omitted.

The net launcher driver 300 is connected to the controller 120 and controls the aiming direction of the net launcher 200 at an instruction from the operator. Also at an instruction from the operator, the net launcher driver 300 simultaneously launches the capturing nets 201. It to be noted that while n this embodiment a single transmitter 151 is used to manipulate the multi-copter 101 and manipulate the net launcher driver 300, it is also possible to manipulate the multi-copter 101 and the net launcher driver 300 using different transmitters, which may be performed by a plurality of human beings. Also, although in this embodiment, capturing of the capturing target T is performed through visual observation of the multi-copter 101 and the capturing target T, another possible configuration is to provide the net launcher driver 300 with a camera pointed in the aiming direction of the net launcher 200 and to manipulate the net launcher driver 300 while checking a moving image at hand picked up by the camera.

### [Procedure for Capturing the Capturing Target]

Description will be made below with regard to a method of capturing the capturing target. T using the multi-copter 101 according to this embodiment.

(1) First, a monitoring person finds a capturing target T that has intruded into an off-limits area. (2) The monitoring person notifies the intrusion to the operator of the multi-copter 101. The monitoring person himself/herself may be the operator of the multi-copter 101. (3) The operator manually manipulates the multi-copter 101 to make the multi-copter 101 approach the capturing target T. (4) When the capturing target T has entered the launching range of the net launcher 200, the operator manipulates the net launcher driver 300 to simultaneously launch the capturing nets 201 toward the capturing target T. (5) After capturing the capturing target T, the operator makes the capturing target T suspended from the airframe of the multi-copter 101 and carries the capturing target T in this state to a predetermined safe dumping site.

This ensures that even a target, such as the capturing target T according to this embodiment, that is difficult to capture down from the ground is quickly disabled because of such a configuration that the multi-copier 101 includes the net launcher 200 and that the net launcher 200 launches the capturing nets 201 from up in the air to capture the capturing target T. Also, in capturing the capturing target T freely moving in the air, the practice to adjust the launching direction of the capturing net 201 by changing the nose direction of the airframe of the multi-copter 101 or by changing the altitude of the multi-copier 101 makes it difficult to follow the quick movements of the capturing target T. The multi-copier 101 includes the net launcher driver 300, which is movable independently of the direction in which the airframe of the multi-copier 101 is pointed. By controlling the direction in which the net launcher 200 is pointed by mainly using the net launcher driver 300, the launching direction of the capturing net 201 is flexibly changeable following the movement of the capturing target T.

It is to be noted that while the net launcher driver 300 according to this embodiment is capable of controlling the aiming direction of the net launcher 200 to change to vertical directions and circumferential directions, it is possible to control the net launcher 200 in circumferential directions by rotating the airframe of the multi-copier 101 and to use the net launcher driver 300 for the sole control of the net launcher 200 in vertical directions.

### Second Embodiment

The second embodiment of the present invention will be described by referring to the accompanying drawings. In the following description, configurations serving identical or similar functions in this and previous embodiment will be denoted the same reference numeral and will not be elaborated further upon here.

### [General Arrangement]

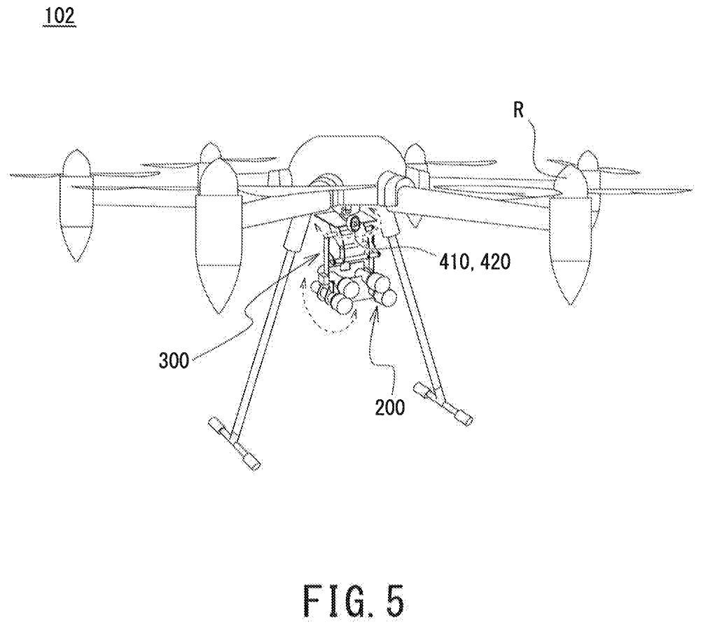

FIG. 5 is a perspective view of an exterior appearance of a multi-copter 102 according to this embodiment. The multi-copter 102 is an unmanned aerial vehicle equipped with six rotors R arranged at equal intervals in a circumferential direction of the airframe. The multi-copter 102, at a lower portion of the airframe, is connected with a net launcher driver 300. On the net launcher driver 300, a net launcher 200 is arranged. The net launcher 200 includes four net launchers. It is to be noted that the number of rotors R may not necessarily be six, similarly to the multi-copter 101 according to the first embodiment.

Also at the lower portion of the airframe of the multi-copter 102, a camera driver 420 is connected. The camera driver 420 holds a stereo camera 410. The camera driver 420 is a device capable of controlling the photographing direction of the stereo camera 410 to change to vertical directions and circumferential directions independently of the direction in which the airframe of the multi-copier 101 is pointed. The camera driver 420 is remote-controllable manually by the operator and/or automatically controllable using an image analysis program IAP, described later.

In this respect, the stereo camera 410 includes a pair of cameras each including an image pick-up device such as CCD and CMOS. These cameras are fixed at a Predetermined base length (optical axis distance) from each other, with the optical axes of the cameras being parallel to each other, so that the cameras pick up images of a target from different viewpoints. Based on a parallax between an object image obtained by the first camera of the stereo camera 410 and an object image obtained by the second camera of the stereo camera 410, a relative position of the object, including distance to the stereo camera 410, is obtained using the principle of triangulation.

### [Configuration of Net Launcher]

The net launcher driver 300 and the net launcher 200 are similar in configuration to the first embodiment and will not be elaborated further upon in this embodiment. The method of arranging the net launchers 210, 220, 230, and 240 will not be limited to the above-described method, similarly to the multi-copter 101 according to the first embodiment.

### [Outline of Functional Configuration]

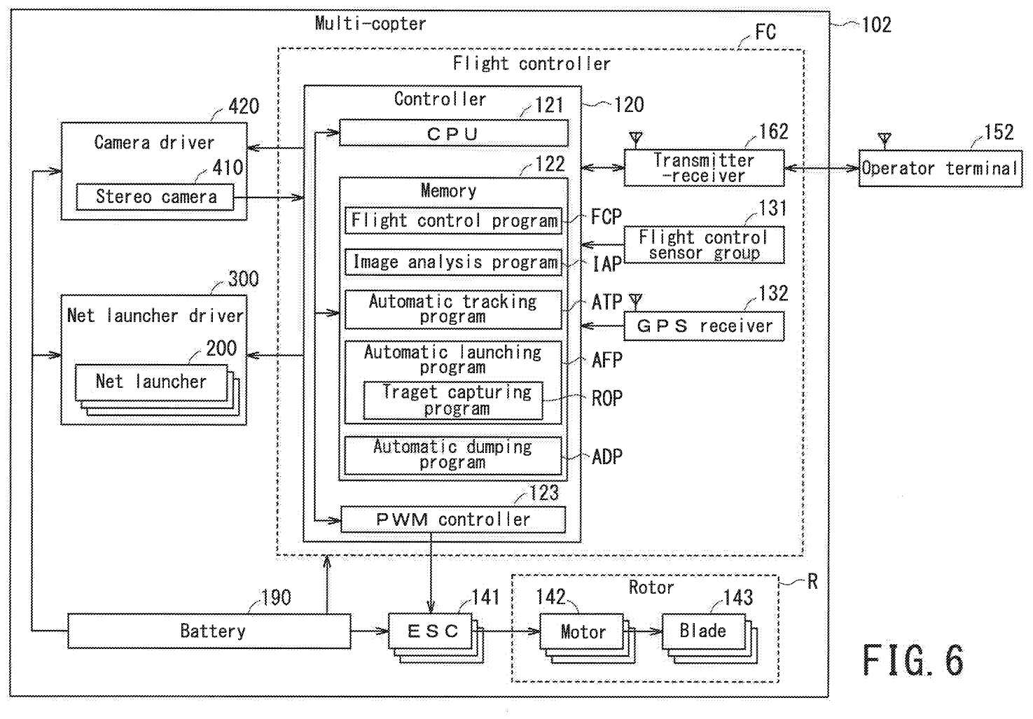

FIG. 6 is a block diagram illustrating a functional configuration of the multi-copter 102. The multi-copter 102 includes, in addition to the functions of the multi-copter 101 according to the first embodiment, various functions to automate the manipulation of the airframe of the multi-copter 102. Also, the multi-copter 102 is capable of transmitting, in a real-time manner, a moving or still image picked up by the stereo camera 410 to an operator terminal 152. From the moving or still image displayed on the operator terminal 152, the operator identifies the capturing target T and notifies the multi-copter 102 of the area of the capturing target T as a template.

### [Automatic Tracking Function]

The multi-copter 102 includes automatic tracking means for obtaining the position of the capturing target. T and for causing the multi-copter 102 to autonomously fly to a predetermined relative position that is based on the position of the capturing target T. The automatic tracking means according to this embodiment includes: the stereo camera 410; the camera driver 420; the image analysis program IAP, which processes a moving or still image of the capturing target T picked up by the stereo camera 410 to obtain a positional relationship including the distance between the multi-copter 102 and the capturing target T; and an automatic tracking program ATP, which causes the airframe to fly autonomously to a position suitable for launching of the capturing nets 201 while using, as a reference, the position of the capturing target T identified by the image analysis program IAP.

In this embodiment, the operator manually identifies the capturing target T from the moving or still image that has been picked up by the stereo camera 410 and that is displayed on the operator terminal 152. Then, the operator notifies the multi-copter 102 of the area of the capturing target T as a template. In this manner, the operator sets a tracking target in the multi-copier 102. In order to implement this operation, the stereo camera 410 is employed in the multi-copier 102 according to this embodiment as means for identifying the position of the capturing target T.

The means for identifying the position of the capturing target T will not be limited to the stereo camera 410; any other means may be employed under the condition that the means is capable of calculating a positional relationship between the multi-copter 102 and the capturing target T. For example, such a method is possible that the multi-copter 102 is equipped with a three-dimensional laser scanner known as 3D-LIDAR or a radar having a level of resolution at which the position of the capturing target T can be identified, and the three-dimensional laser scanner or the radar continually monitors the air from the ground to automatically detect and track the capturing target T. Another possible method is that the operator manipulates the multi-copter 102 to recognize, as the capturing target T, a moving object closest to the multi-copter 102 in the monitoring direction of, for example, the stereo camera 410.

After the capturing target T has been recognized, the image analysis program IAP automatically controls the photographing direction of the camera driver 420 so that the capturing target T is at any time located at the center of the field of vision of the stereo camera 410.

The automatic tracking program ATP not only directs the multi-copter 102 toward the current position of the capturing target T, but also causes the multi-copter 102 to fly toward a position suitable for launching of the capturing nets 201 with the current position of the capturing target T taken as a reference (in this embodiment, the multi-copter 102 is caused to fly toward a position diagonally above the capturing target T). The position suitable for launching of the capturing nets 201 varies depending on the configuration and/or performance of the airframe and/or the net launchers or depending on characteristics of the capturing target. In light of this, it is necessary to adjust the position according to relevant conditions. It is to be noted that while the automatic tracking program ATP according to this embodiment determines the flight destination using only the current position of the capturing target T as a reference, another possible configuration is to determine a position suitable for launching of the capturing nets 201 with the movement speed of the capturing target T taken as an additional consideration.

Thus, in this embodiment, the multi-copter 102 is capable of automatically tracking the capturing target T. This enables the operator of the multi-copter 102 to focus on the manipulation of the net launcher driver 300 even though the multi-copter 102 is not equipped with an automatic launching function, described later. This increases the success rate of capturing the capturing target T.

### [Target Capturing Function and Automatic Launching Function]

The multi-copter 102 further includes: target capturing means for automatically changing the aiming direction of the net launcher 200 to a direction toward the capturing target T; and automatic launching means for automatically launching the capturing net 201 upon entering of the capturing target T into the launching range of the net launcher 200. The target capturing means according to this embodiment includes the stereo camera 410, the camera driver 420, the image analysis program IAP, and a target capturing program ROP. The target capturing program ROP controls the net launcher driver 300 based on the positional relationship between the capturing target T and the multi-copter 102 identified by the image analysis program IAP so as to automatically change the aiming direction of the net launcher 200 to a direction toward the capturing target T. The automatic launching means includes the target capturing means and an automatic launching program AFP, which automatically launches the capturing net 201 at the timing when the capturing target T enters the launching range.

Thus, in this embodiment, the multi-copter 102 includes the automatic tracking means for the capturing target T, the target capturing means for the capturing target T, and the automatic launching means for the capturing nets 201. This ensures that all of the airframe manipulation is automated after the capturing target T has been identified. This realizes quick judgments and manipulations that are impossible to make manually, ensuring that the capturing target T can be captured more reliably.

As in this embodiment, when the capturing target T is an object that moves in the air at high speed, the capturing target T may escape from the capturing net 201 due to a time difference between the launching of the capturing net 201 and the reaching of the capturing net 201 to the capturing target T. This is notable when, for example, the movement speed of the capturing target T is higher than that of the multi-copter 102, making it difficult to make the distance between the multi-copter 102 and the capturing target T sufficiently short.

In this case, based on the time difference the launching of the capturing net 201 and the reaching of the capturing net. 201 to the capturing target T, it is possible to estimate the position of the capturing target T at the point of time when the capturing net 201 reaches the capturing target T and to determine the launching direction of the capturing net 201 based on the estimated position. This increases the success rate of capturing the capturing target. T.

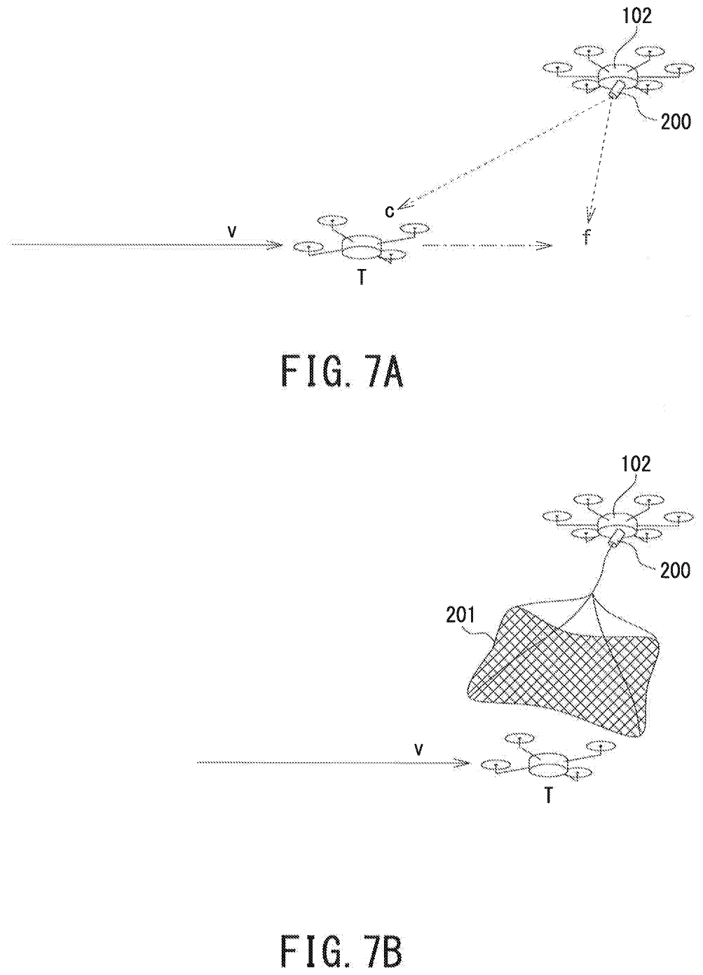

FIGS. 7A and 7B illustrate schematics illustrating a process by which the multi-copter 102 according to this embodiment captures the capturing target T. FIG. 7A is a schematic illustrating how the target capturing program ROP adjusts the launching direction of the capturing net 201. FIG. 7B is a schematic illustrating how the automatic launching program AFP launches the capturing net 201.

In FIG. 7A, assume that the capturing target T was flying at a predetermined speed in the direction in which arrow v is pointed. In this respect, the target capturing program ROP of the multi-copter 102 does not direct the net launcher 200 toward the current position c of the capturing target T. Instead, based on the current movement direction and current movement speed of the capturing target T, the target capturing program ROP estimates the position, f, of the capturing target T at the point of time when the capturing net 201 reaches the capturing target T. Then, the target capturing program ROP directs the net launcher 200 toward the position f. Then, as illustrated in FIG. 7B, upon entering of the capturing target T into the launching range of the net launcher 200, the automatic launching program AFP of the multi-copter 102 launches the capturing net 201 toward the position f.

Thus, based on the time difference between the launching of the capturing net 201 and the reaching of the capturing net 201 to the capturing target T, the multi-copter 102 according to this embodiment determines the launching direction of the capturing net 201. This ensures that the capturing target T moving at high speed can be captured more reliably.

It is to be noted that while the automatic launching program AFP according to this embodiment causes the net launcher 200 to launch the capturing nets 211 simultaneously, the net launcher 200 may not necessarily launch the capturing nets 211 simultaneously all the time; the net launcher 200 may launch the capturing nets 211 sequentially. This ensures that even when, for example, the estimation of movement of the capturing target T was a mis-estimation and the capturing target T has escaped from the capturing net 211, repeating the estimation operation and the launching operation a plurality of times increases the possibility of the capturing target T positioned as estimated.

### [Automatic Dumping Function]

The multi-copter 102 further includes automatic dumping means for, after capturing the capturing target T using the capturing net 201, carrying the capturing target T in suspended state to a predetermined dumping position, for dumping the capturing target T to the dumping position, and for making a returning movement. The automatic dumping means according to this embodiment includes an automatic dumping program ADP.

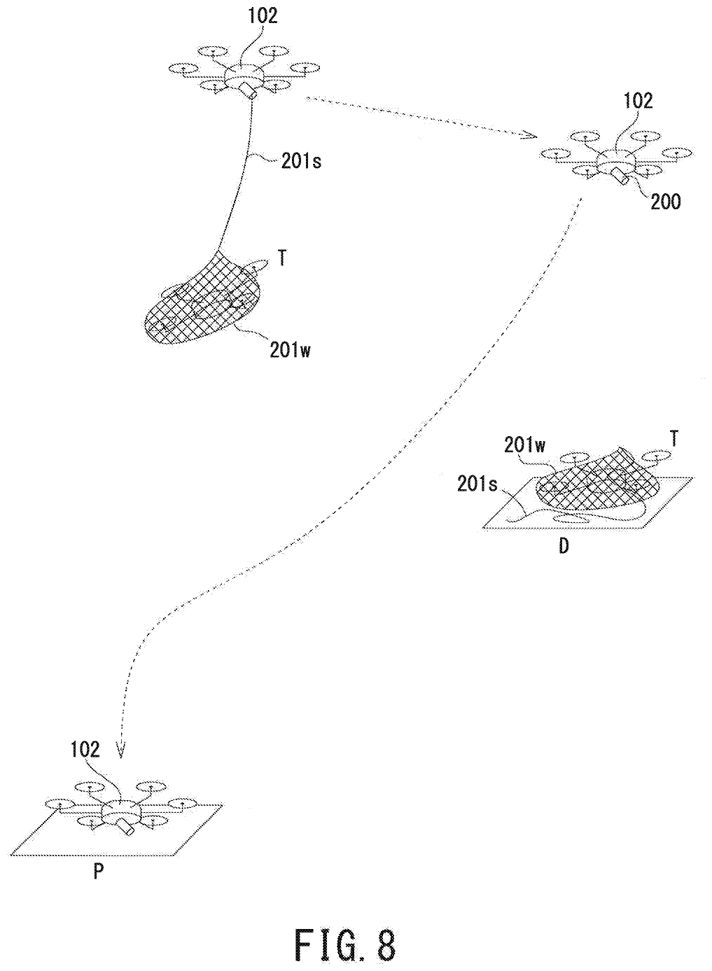

FIG. 8 is a schematic illustrating how the automatic dumping program ADP causes the multi-copter 102 to dump the captured capturing target T to a dumping site D and make a returning movement to a landing platform P. As illustrated in FIG. 8, upon detection of a capturing of the capturing target T, the multi-copter 102 causes the airframe to fly autonomously to the dumping site D with the capturing target T in a suspended state. Then, in the air over the dumping site D, the multi-copter 102 cuts the string-shaped portion 201s, and then automatically makes a returning movement to and lands on the landing platform P of the multi-copier 102.

The automatic dumping program ADP may detect a capturing of the capturing target T in the following manner. For example, the automatic dumping program ADP may determine whether a capturing has been done based on a change in the weight of the multi-copter 102, such as: an increase in the number of rotations of the rotors R and an increase in current consumption at the hovering time before and after the launching of the capturing nets 201. For further example, the automatic dumping program ADP may determine whether a capturing has been done based on an increase in tensile stress of the string-shaped portion 201s.

As in this embodiment, when the capturing target T is an object that flies in the air, the capturing target T is captured using a capturing net or another capturing device, becomes unable to fly, and falls on the ground. If there is a structure or a pedestrian on the falling spot, the falling of the capturing target T may lead to an accident. In the multi-copter 102 according to this embodiment, such an accident can be avoided in advance by connecting the spreadable portion 201w of the capturing net 201 to the net launcher 200 through the string-shaped portion 201s and by, after capturing the capturing target T, making the captured capturing target T suspended from the airframe and carrying the capturing target T to the dumping site D. This eliminates or minimizes accidents otherwise caused by the fallen capturing target T.

It is to be noted that while the automatic dumping program ADP according to this embodiment is designed to, after causing the multi-copter 102 to dump the capturing target T to the dumping site D, cause the multi-copter 102 to automatically make a returning movement to the landing platform P, another possible configuration is to cause the multi-copter 102 to land on the dumping site D together with the capturing target T.

Also, while in this embodiment a single controller 120 is used to execute all the programs for automating airframe manipulation, it is also possible to, if this is too much a load, provide the multi-copter 102 with a plurality of controllers and cause the controllers to execute some of the programs. Also, these programs may not necessarily be mounted all the time; adequate effects can be obtained even when only some of the programs are mounted. For example, an airframe may include only the target capturing means, among the above-described functions, so that the net launcher 200 launches the capturing net at any desired timing for the operator. With this configuration, the airframe is able to capture a capturing target flexibly and at high capturing success rates under various conditions.

### [Procedure for Capturing the Capturing Target]

Description will be made below with regard to a method of capturing the capturing target T using the multi-copter 102 according to this embodiment.

(1) First, a monitoring person finds a capturing target T that has intruded into an off-limits area. (2) The monitoring person notifies the intrusion to the operator of the multi-copter 102. The monitoring person himself/herself may be the operator of the multi-copter 102. (3) The operator manually manipulates the multi-copier 102 to pick up a moving or still image of the capturing target T using the stereo camera 410 and to notify the multi-copter 102 of the capturing target T shown in the moving or still image. (4) The multi-copter 102 automatically approaches the capturing target T using the automatic tracking means. (5) The multi-copier 102 estimates a moving path of the capturing target T using the target capturing means and the automatic launching means, and automatically launches the capturing nets 201 simultaneously upon entering of the capturing target T into the launching range of the net launcher 200. (6) The multi-copter 102, after capturing the capturing target T, uses the automatic dumping means to carry the capturing target T to the dumping site D with the capturing target T suspended from the airframe, dumps the capturing target T to the dumping site D, and automatically makes a returning movement to the landing platform P of the multi-copter 102.

It is to be noted that (1) to (3) of the procedure may be omitted when, for example, the multi-copter 102 uses the stereo camera 410 or a similar device to continually monitor the space over an off-limits area from the ground, so that the multi-copter 102 is able to automatically detect a capturing target T.

### Third Embodiment

The third embodiment of the present invention will be described by referring to the accompanying drawings. In the following description, configurations serving identical or similar functions in this and previous embodiment will be denoted the same reference numeral and will not be elaborated further upon here.

### [General Arrangement]

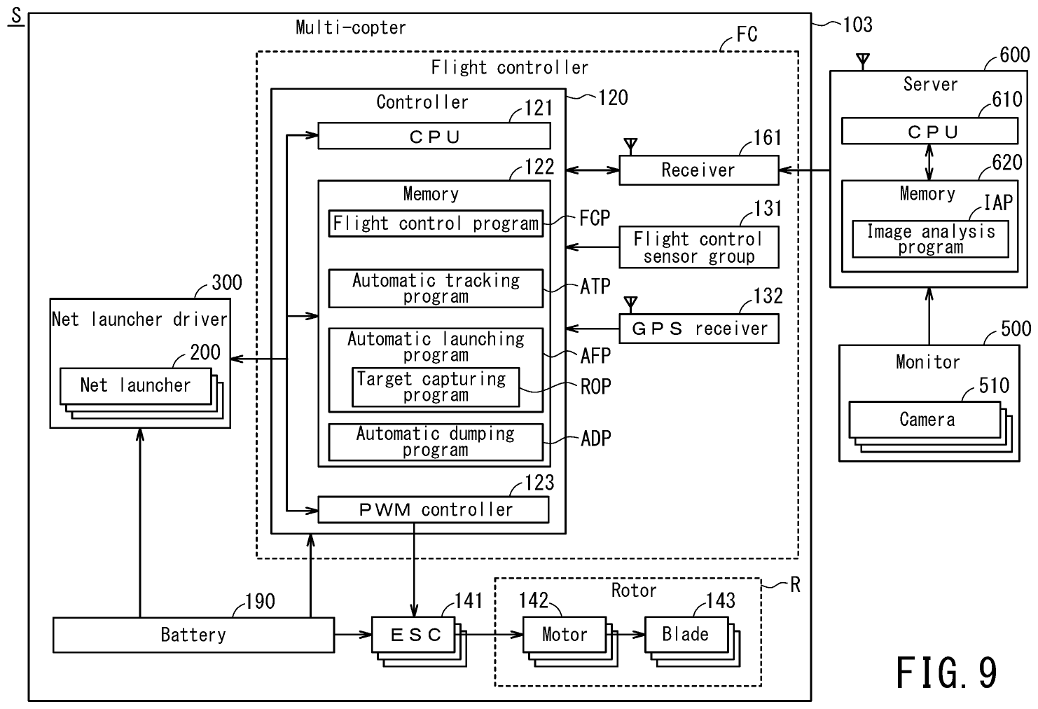

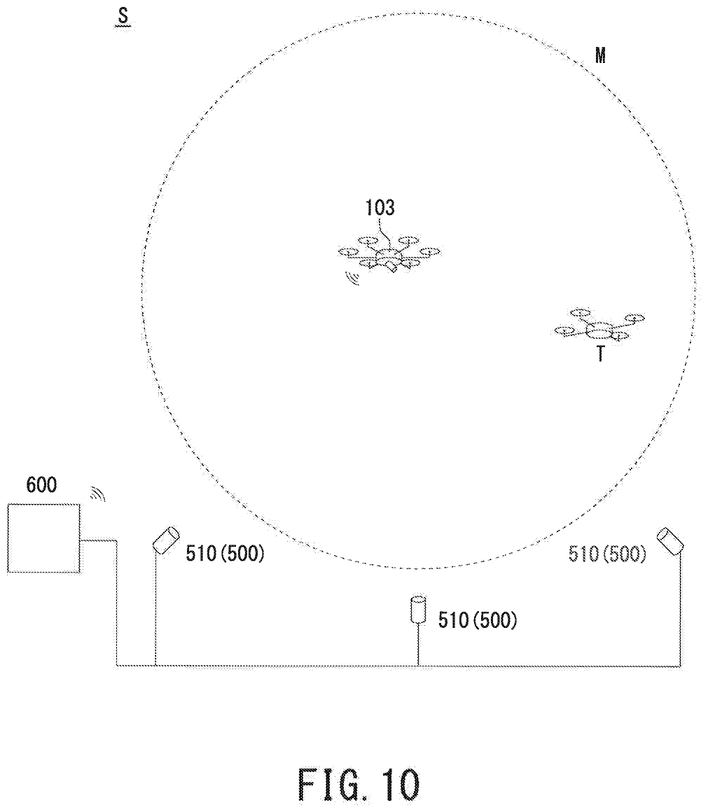

FIG. 9 is a block diagram illustrating a functional configuration of a moving object capturing system S. FIG. 10 is a schematic outlining the moving object capturing system S. The moving object capturing system S mainly includes: a monitor 500, which monitors an off-limits area; a multi-copter 103, which is an unmanned aerial vehicle; and a server 600, which is an intermediate processor communicable with the monitor 500 and the multi-copter 103. In the following description, the space in the off-limits area that is monitored by the monitor 500 will be referred to as “monitored space M”.

### [Configuration of Monitor]

The monitor 500 includes a plurality of cameras 510, which are monitoring means, and uses the cameras 510 to pick up images of the monitored space M from multiple directions, thereby identifying a three-dimensional position of an object in the monitored space M.

The monitoring means of the monitor 500 will not be limited to the cameras 510 according to this embodiment. There are other possible examples of the monitoring means than the cameras 510, with such a requirement that the monitoring means is capable of detecting an intrusion of a moving object into the monitored space M and capable of obtaining monitoring information from which a three-dimensional position of the moving object in the monitored space M is identifiable. An example is a three-dimensional laser scanner known as 3D-LIDAR. Another example is a radar having a level of resolution at which the position of the capturing target T can be identified. Still another example is means for accepting an input signal in the form of sound and for identifying the position of the source of the sound.

### [Configuration of Server]

The server 600 is a typical server computer that includes: a CPU 610, which is a central processing unit; and a memory 620. The memory 620 includes a RAM serving as a main storage and an HDD serving as an auxiliary storage.

The server 600 includes the image analysis program IAP, which is means for identifying the position of the capturing target T. The image analysis program LAP processes a moving or still image picked up by the monitor 500 and detects an intrusion of the capturing target T into the monitored space M. The image analysis program IAP also identifies a three-dimensional position of the capturing target T in the monitored space M.

### [Configuration of Multi-Copier]

The multi-copter 103 is equivalent to the multi-copter 102 according to the second embodiment without the configurations associated with identifying of the position of the capturing target T (the stereo camera 410, the camera driver 420, the image analysis program IAP, and a transmitter-receiver 162, which transmits to the operator the moving or still image picked up by the stereo camera 410 and receives a template of the capturing target T). Other configurations are similar to corresponding configurations of the multi-copter 102 according to the second embodiment and will not be elaborated upon in this embodiment. The multi-copter 103 obtains from the server 600 the three-dimensional position of the capturing target T and autonomously flies to a predetermined relative position that is based on the three-dimensional position. Then, the multi-copter 103 automatically captures the capturing target T and dumps the capturing target T.

### [Procedure for Capturing the Capturing Target]

Description will be made below with regard to a method of capturing the capturing target T using the moving object capturing system S according to this embodiment.

(1) The monitor 500 continually transmits to the server 600 a moving or still image of the monitored space M, which is monitoring information. (2) The server 600 detects an intrusion of the capturing target. T into the monitored space M and continually notifies the multi-copter 103 of a change in the position of the capturing target T. (3) The multi-copter 103 automatically approaches the capturing target T using the automatic tracking means. (4) The multi-copter 103 estimates a moving path of the capturing target T using the target capturing means, and automatically launches the capturing nets 201 simultaneously upon entering of the capturing target T into the launching range of the net launcher 200 using the automatic launching means. (6) The multi-copier 103, after capturing the capturing target T, uses the automatic dumping means to carry the capturing target T to the dumping site D with the capturing target T suspended from the airframe, dumps the capturing target T to the dumping site D, and automatically makes a returning movement to the landing platform P of the multi-copter 103.

Thus, the moving object capturing system S according to this embodiment assigns the functions necessary for capturing the capturing target T to: the monitor 500, which obtains monitoring information of the monitored space M; the server 600, which identifies the position of the capturing target T from the monitoring information; and the multi-copter 103, which tracks and captures the capturing target T based on the position information identified by the server 600. This ensures that the capturing target T is captured more reliably and more efficiently.

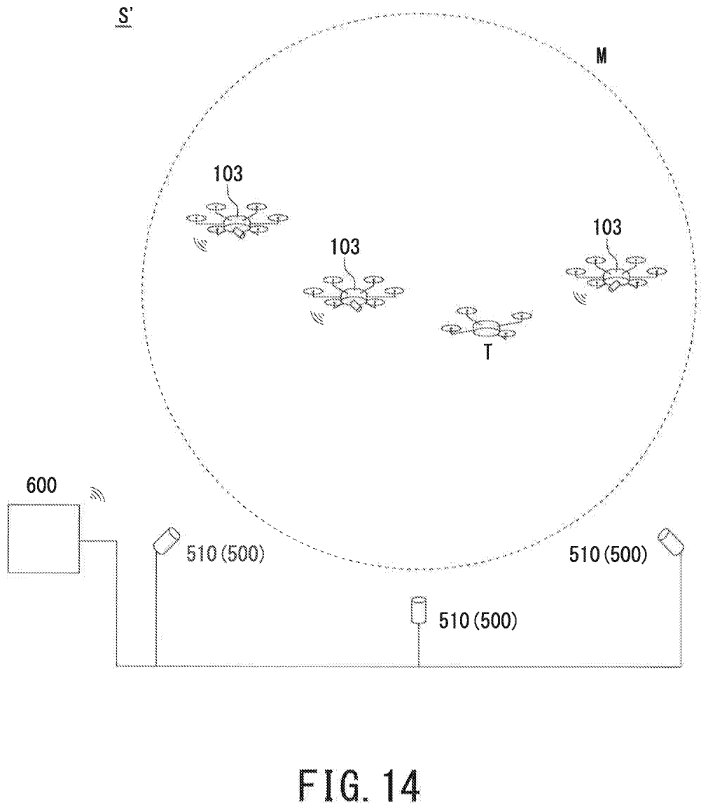

Also, the moving object capturing system S may not necessarily include a single multi-copter 103 but may include a plurality of multi-copters 103. FIG. 14 is a schematic outlining a moving object capturing system S′, which uses a plurality of multi-copters 103. As illustrated in FIG. 14, a possible method of using a plurality of multi-copters 103 is that the multi-copters 103 are located at different positions relative to the position of the capturing target T. Another possible method is that the monitored space M is divided into a plurality of areas and each of the multi-copters 103 has a different movable area among the plurality of areas. This increases the success rate of capturing the capturing target T as compared with the case of a single multi-copter 103.

Embodiments of the present invention has been described hereinbefore. The present invention, however, will not be limited to the above-described embodiments but may have various modifications without departing from the scope of the present invention. For example, while in the above-described embodiments the capturing target T is a multi-copter, the unmanned aerial vehicle and the moving object capturing system according to the present invention are also effective in applications in which the capturing target is a human being or an animal. In this case, an advantage is that the capturing target can be disabled remotely, with the operator himself/herself located at a safe place.

1. A moving object capturing system configured to capture a capturing target, the moving object capturing system comprising:
a monitor configured to monitor a predetermined space;
an unmanned aerial vehicle comprising a plurality of rotary wings; and
an intermediate processor communicable with the monitor and the unmanned aerial vehicle,
wherein the unmanned aerial vehicle comprises a Capturing net launching device configured to launch and spread a capturing net,
wherein the monitor comprises monitoring means for obtaining monitoring information that is information indicating a state of a monitored space of the monitor,
wherein the intermediate processor comprises position identifying means for detecting, based on the monitoring information, the capturing target that has entered the monitored space, and for identifying a position of the capturing target in the monitored space, and
wherein the unmanned aerial vehicle is configured to obtain the position of the capturing target identified by the intermediate processor.

2. The moving object capturing system according to claim 1, comprising a plurality of the unmanned aerial vehicles,
wherein the intermediate processor is communicable with the plurality of the unmanned aerial vehicles.

3. The moving object capturing system according to claim 2, wherein each of the unmanned aerial vehicles is configured to obtain the position of the capturing target identified by the intermediate processor and fly autonomously to a different relative position that is based on the position of the capturing target.

4. The moving object capturing system according to claim 2, wherein the unmanned aerial vehicles have different movable ranges in the monitored space.

5. The unmanned aerial vehicle according to claim 1, further comprising:
a launching direction controller configured to hold the capturing net launching device to control an aiming direction of the capturing net launching device independently of a direction in which an airframe of the unmanned aerial vehicle is pointed;
wherein the launching direction controller holds a plurality of the capturing net launching devices, and
wherein the launching direction controller holds the plurality of the capturing net launching devices at such launching angles that when the plurality of the capturing net launching devices have launched the capturing nets simultaneously, the spread capturing nets are substantially out of contact with each other with no or minimal gaps between the spread capturing nets.

6. The unmanned aerial vehicle according to claim 5, wherein the plurality of the capturing net launching devices are disposed in a suitable arrangement and at suitable launching angles enough to cover an estimated movable range that is based on a movement characteristic of a capturing target.

7. The unmanned aerial vehicle according to claim 6, wherein the plurality of the capturing net launching devices are arranged such that one capturing net launching device of the plurality of the capturing net launching devices is located at a center of the plurality of the capturing net launching devices, and other capturing net launching devices are located at horizontal sides of the one capturing net launching device and perpendicularly above the one capturing net launching device.

8. The unmanned aerial vehicle according to claim 1, wherein the capturing net comprises
a spreadable portion spreadable to become entangled with a capturing target after the capturing net has been launched, and
a string-shaped portion connecting the spreadable portion and the capturing net launching device to each other, and
wherein the capturing net launching device comprises a winch configured to wind out and wind up the string-shaped portion.

9. The unmanned aerial vehicle according to claim 1, comprising automatic launching means for automatically launching the capturing net upon entering of the capturing target into a launching range of the capturing net launching device.

10. The unmanned aerial vehicle according to claim 9, wherein based on a time difference between a launching of the capturing net and a reaching of the capturing net to the capturing target, the automatic launching means is configured to estimate the position of the capturing target at a point of time when the capturing net reaches the capturing target, and configured to adjust the launching direction of the capturing net based on the estimated position.

11. The unmanned aerial vehicle according to claim 9, further comprising:
a launching direction controller configured to hold the capturing net launching device to control an aiming direction of the capturing net launching device independently of a direction in which an airframe of the unmanned aerial vehicle is pointed;
wherein the launching direction controller holds a plurality of the capturing net launching devices, and
wherein the automatic launching means is configured to sequentially launch the capturing nets from the capturing net launching devices.

12. The unmanned aerial vehicle according to claim 1,
wherein the capturing net comprises
a spreadable portion spreadable to become entangled with a capturing target after the capturing net has been launched, and
a string-shaped portion connecting the spreadable portion and the capturing net launching device to each other, and
wherein the unmanned aerial vehicle comprises automatic dumping means for, after capturing the capturing target using the capturing net, carrying the capturing target to a predetermined dumping position with the capturing target in a suspended state, and for dumping the capturing target to the dumping position and causing the unmanned aerial vehicle to make a returning movement or land on the dumping position.
